(19) United States
(12) Patent Application Publication
(10) Pub. No.: US 2008/0230322 A1
(43) Pub. Date: Sep. 25, 2008

(54) Small Power Elevator

(76) Inventor: Woon Tae Chung, Busan (KR)

Correspondence Address: FRANKLIN & ASSOCIATES INTERNATIONAL LLC, 230 St. Francis Drive, Suite 1, SANTA FE, NM, 87505-3538, US

(21) Appl. No.: 12/065,899

(22) PCT Filed: Sep. 5, 2006
(86) PCT No.: PCT/KR2006/003508

§ 371 Date: Mar. 6, 2008

(30) Foreign Application Priority Data
Sep. 7, 2005 (KR) 10-2005-0083926
Jun. 14, 2006 (KR) 10-2006-0053575

(51) Int. Cl. B66B 1/44

(52) U.S. Cl. 187/250

(57) ABSTRACT

A small power elevator system is installed in an elevator shaft of a building. The system includes a passenger or freight elevator car having an electronic scale installed in a bottom thereof to measure the weight of passengers or freight loaded therein; a counterweight connected to the elevator car and adapted to be moved in a direction opposite that of the elevator car by mass members added or removed according to the weight of the elevator car; a mass member feeder for feeding the mass members to the counterweight; and a control unit for controlling the mass members to be fed from the mass member feeder to the counterweight or discharged from the counterweight to the mass member feeder according to the weight of the elevator car. The system can reduce power consumption to thereby reduce electric charges such as basic rates and usage rates.

### TECHNICAL FIELD

The present invention relates to a small power elevator, and more particularly to a small power elevator system designed to operate according to the principle of a well bucket in order to reduce power consumption.

### BACKGROUND ART

In general, an elevator system is an apparatus that moves vertically along a rail using mechanical power to carry passengers or freight. The elevator system is a type of lift equipment, that is, the general term for transport equipment including an escalator and a dumbwaiter.

A cable type elevator system generally uses a counterweight. This type is to move an elevator car based on the frictional force between a winding sheave (pulley) and a wire cable, in which a counterweight is connected to the opposite end of the wire cable from the car, like a well bucket.

This existing elevator system is operated by speed control through gear shifting or an inverter, in which a wire cable is connected to a hoist that is directly coupled to a drive motor installed in a machine room in a top portion of a building. In a case where the drive motor has a capacity of 11 kW, a dedicated transformer needs a capacity of about 50 KVA. A shared transformer has practical problems: operation and suspension cause voltage fluctuations, and harmonics, generated upon inverter operation, have adverse effects on other devices.

In addition, the operation of the elevator system results in a high electrical cost owing to basic rates and excessive usage rates, and the high transformer capacity increases no-load loss at midnight.

Since conventional elevator systems consume an excessive amount of power to hoist an elevator car, the transformer is required to have a large capacity. In addition, since an emergency power generator in case of power failure is required to supply electrical power to the elevator system, the emergency power generator is also required to have a large capacity with increased maintenance cost. In general, the conventional elevator systems have the following problems: electric charges are high, the maintenance cost is high, and a large installation area is needed, owing to the high capacity transformer and the emergency power generator. Moreover, the large capacity emergency power generator that is used generates noise and causes environmental problems owing to pollution.

### DISCLOSURE OF INVENTION

### Technical Problem

The present invention has been devised to solve the foregoing problems, and it is therefore an object of the invention to provide a small power elevator system capable of reducing power consumption to thereby reduce electric charges, such as basic rates and usage rates.

### Technical Solution

According to an aspect of the invention for realizing the foregoing object, the invention provides a small power elevator system installed in an elevator shaft of a building. The small power elevator system includes a passenger or freight elevator car having an electronic scale installed in a floor thereof to measure the weight of passengers or freight loaded; a counterweight connected to the elevator car and adapted to be moved in the opposite direction to the elevator car by mass members added or removed according to the weight of the elevator car; a mass member feeder for feeding the mass members to the counterweight; and a control unit for controlling the mass members to be fed from the mass member feeder to the counterweight or discharged from the counterweight to the mass member feeder according to the weight of the elevator car. In case of driving the elevator car upward, the total weight of the elevator car and the passengers or freight is measured, and the mass members are fed to the counterweight, so that the counterweight has a total weight larger than that of the elevator car to drive the elevator car upward, and in the case of driving the elevator car downward, the total weight of the elevator car and the passengers or freight is measured and the mass members are discharged from the counterweight so that the counterweight has a total weight less than that of the elevator car, thus allowing the elevator car to be moved down by its own weight.

Preferably, the counterweight includes: a box having a mass member inlet for receiving the mass members from the mass member feeder, and a mass member outlet installed in a lower portion of the box to discharge a certain amount of the mass members to the mass member feeder in response to a control signal from the control unit; and an electronic scale installed in the floor of the box to measure the weight of the mass members inside the box and send a measurement value to the control unit.

Preferably, the mass member feeder includes: a first mass member hopper arranged in an upper portion of the elevator shaft to feed a certain amount of the mass members to the counterweight in response to a control signal from the control unit; a second mass member hopper arranged in a lower portion of the elevator shaft to collect the mass members discharged from the counterweight; and a feed screw unit including a casing having an inlet formed at one portion thereof, an outlet formed at another portion thereof, an inner space, a feed screw arranged inside the inner space of the casing, and a transport pipe. When the mass members discharged from the second mass member hopper are received through the inlet of the casing, the feed screw transports the mass members upward through the outlet of the casing and the feeding pipe using the rotating force of the drive motor in order to feed the mass members to the first mass member hopper.

Preferably, the first mass member hopper includes: a mass member container fixed to one portion of the elevator shaft to collect the mass members fed from a conveyor belt of the feed screw unit, the mass member having a feeding hole in a lower portion thereof; a plurality of openable doors arranged vertically to separate the inner space of the mass member container into a plurality of areas; and a movable pipe for guiding the mass members exiting through the feeding holes of the mass member container to the counterweight. The openable doors are selectively opened/closed in response to the control signal from the control unit to feed the mass members to the counterweight.

Preferably, the second mass member hopper includes: a mass member container fixed to one portion of the elevator shaft to collect the mass members discharged from the counterweight; and a movable pipe arranged in an upper portion of the mass member container to guide the mass members discharged from the counterweight.

In addition, preferably, the elevator car has a graphic monitor installed on an inner wall surface to display the mass members being fed or discharged.

### ADVANTAGEOUS EFFECTS

According to the invention as described above, it is possible to drive the elevator car upward using the weight of the mass members which are hoisted by the small power conveyor belt, after which the elevator car can be moved down by its own weight. As a result, electric charges are halved compared to conventional elevator systems, thereby remarkably reducing power consumption.

An uninterruptable power supply can be provided at the bottom of the elevator shaft in preparation for an accident concerning elevator stability. This also can reduce the amount of power consumption and stably supply power so that the elevator system can be stably operated according to the capacity of the uninterruptable power supply in the event of a power failure.

Furthermore, the elevator system of the invention is suitable for elevator systems for emergencies and observations, and for high speed elevator systems. When used for these applications, the elevator system of the invention can save more energy and enhance safety. The elevator system of the invention is also applicable to a freight lift having a large capacity.

Moreover, in the invention, it is possible to supply electric power generated from the drive motor during regenerative braking to an aeration tank, thereby reducing the amount of power consumed by the aeration tank.

### BRIEF DESCRIPTION OF THE DRAWINGS

FIG. 1 is a perspective view illustrating a small power elevator system of the invention;

FIG. 2 is a side elevation view schematically illustrating the counterweight of the invention;

FIG. 3 is a side elevation view schematically illustrating the small power elevator system of the invention;

FIG. 4 is a side elevation view schematically illustrating a feed screw unit of the invention;

FIG. 5 is a view illustrating the elevator system according to a preferred embodiment of the invention, in which the elevator car has arrived at the top floor and the counterweight has arrived at the bottom floor;

FIG. 6 is a view illustrating the elevator system according to another preferred embodiment of the invention, in which the elevator car has arrived at the top floor and the counterweight has arrived at the bottom floor; and

FIG. 7 is a perspective view illustrating a small power elevator system according to a further preferred embodiment of the invention.

### MAJOR REFERENCE SIGNS OF THE DRAWINGS

1: mass member
2: hoist
3: governor
4: main cable
5: traveling cable
10: elevator car
20: counterweight
30: mass member feeder
40: control unit
110: electronic scale
120: graphic monitor
210: box
212: mass member inlet
214: mass member outlet
220: electronic scale
310: first mass member hopper
312: mass member container
314: openable door
316: mass member feeding hole
318: movable pipe
320: second mass member hopper
322: mass member container
324: movable pipe
330: feed screw unit
331: inlet
332: outlet
333: casing
334: feed screw
335: drive motor
336: transport pipe
340: bucket conveyor unit
342: vertical conveyor
344, 344′: ratchet gear
346: bucket
348: tension gear

### BEST MODE FOR CARRYING OUT THE INVENTION

Hereinafter, the small power elevator system of the invention will be described in detail in conjunction with the accompanying drawings.

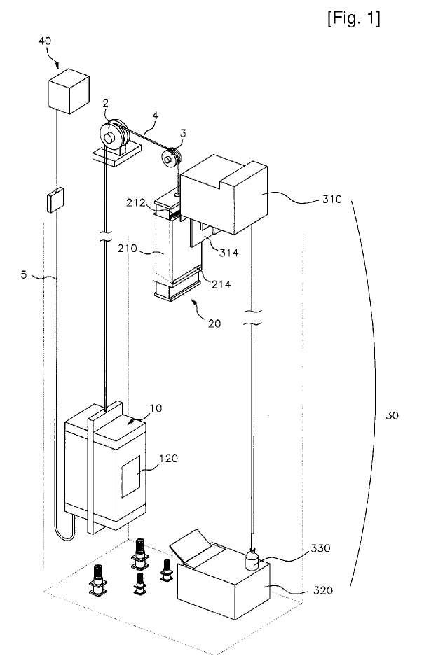

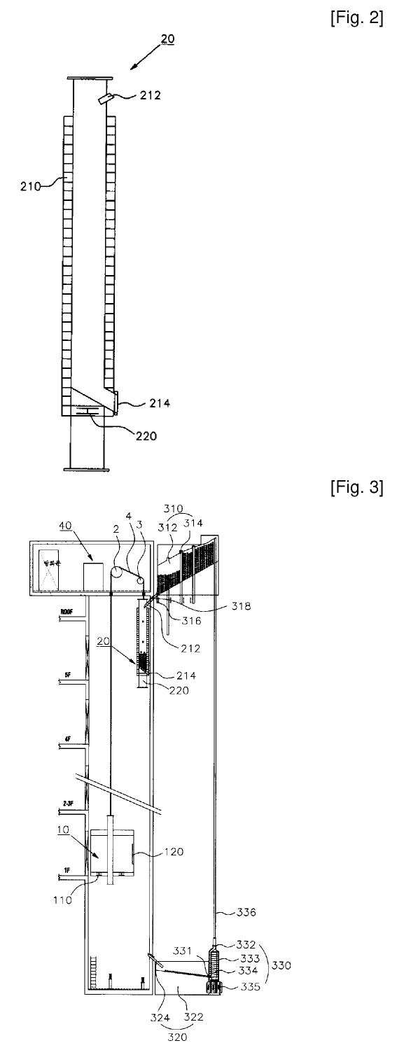

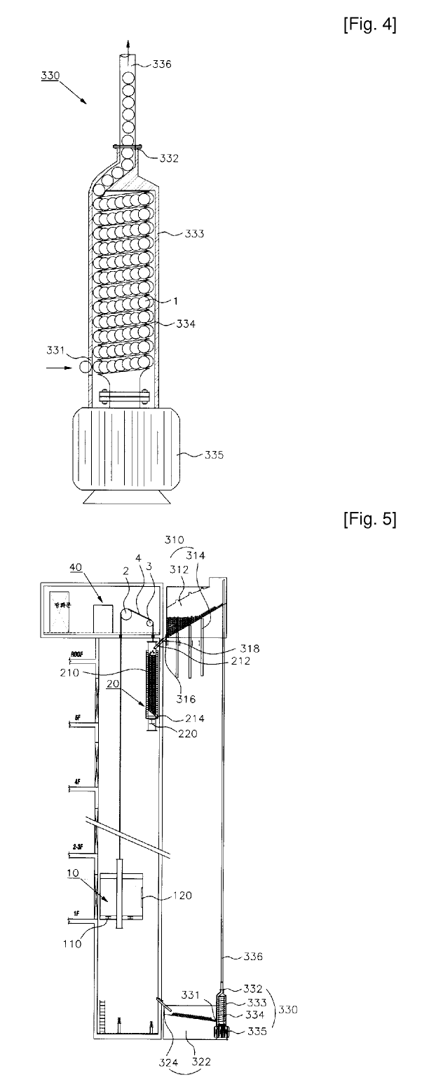

FIG. 1 is a perspective view illustrating a small power elevator system of the invention, FIG. 2 is a side elevation view schematically illustrating the counterweight of the invention, FIG. 3 is a side elevation view schematically illustrating the small power elevator system of the invention, and FIG. 4 is a side elevation view schematically illustrating a feed screw of the invention.

Referring to FIGS. 1 to 4, the small power elevator system of the invention is designed to supply necessary mass members 1 to a counterweight 20 in consideration of a comparison of the weight of an elevator car 10 and passengers with that of a counterweight 20 in order to assist the operation of the elevator system. The small power elevator system also employs various auxiliary units necessary for the operation of general elevator systems, such as a door closing unit, an automatic landing device, an electronic brake, electric control devices (e.g. a receiver board, controller, signal board and flow control device), guide rails, cables, a governor, a buffer, a speed governor (for dual protection), slow-down switches on all floors from the top to the bottom floors, motion switches on the top and bottom floors for use in the event that the slow-down switches do not operate, a retiring cam, a door safety switch, and other safety devices.

Referring to FIG. 1, the small power elevator system of the invention is generally composed of the elevator car for carrying passengers or freight, the counterweight 20 arranged opposite the elevator car 10 to be balanced with the elevator car 10, a mass member feeder 30 supplying the mass members 1 to the counterweight 20, and a control unit 40 electrically connected to the former components. These components will be described respectively below.

First, the elevator car 10 is designed to carry passengers or freight, and has an electronic scale 110, for weighing passengers or loaded freight, installed in the bottom of the elevator car 10. The weight measured by the electronic scale 110 is transferred to the control unit 40. The electronic scale 110 is preferably installed near overload equipment.

A graphic monitor 120 is installed inside the elevator car 10 to display the mass members 1 being fed into or discharged from the counterweight 20 to the passengers so that the passengers do not become bored during the feeding/discharging of the mass members 1. In addition, a brake operates to stop the elevator system during the feeding/discharging of the mass members 1.

The mass members 1 are preferably steel balls. The mass members 1 are steel balls because steel has a specific gravity of 7.8 compared to water, which has a specific gravity of 1, and thus can reduce volume greatly. Using a feed screw or conveyor belt, about 2 tons of the mass members 1 can drive the elevator car to the top portion of a building, thereby advantageously reducing running time.

Referring to FIG. 2, the counterweight 20 is arranged opposite the elevator car 10 to be moved by a hoist 2, a governor 3 and a main cable 4 in the direction opposite that of the elevator car 10, in which the mass members 1 are added to or removed from the counterweight 20 according to the weight of the elevator car 10. The counterweight 20 has a box 210 therein for receiving the mass members 1 to drive the elevator car upward/downward in place of driving force from a common drive motor.

In addition, the counterweight 20 has a mass member inlet 212 formed in an upper portion of the box 210 and a mass member outlet 214 formed in a lower portion of the box 210, through which the mass members 1 are introduced by or discharged into the mass member feeder 30, which will described later.

The box 210 is provided with a slant at the bottom to guide the mass members 1 toward the mass member outlet 214 and an electronic scale 220 installed inside the bottom to measure the total weight of the mass members 1 loaded inside the box 210 and send a measurement signal to the control unit 40.

As shown in FIGS. 1 and 2, the mass member feeder 30 serves to feed the mass members 1 to the counterweight 20, and includes a first mass member hopper 310, a second mass member hopper 320 and a feed screw unit 330, which are arranged from top to bottom ends of an elevator shaft.

The first mass member hopper 310 is installed in an upper part of the elevator shaft, and has a mass member container 312 for collecting the mass members 1 dropping from the feed screw unit 330, which will be described later in detail, and a plurality of vertical doors 314 for separating the inner space of the mass member container 312 into a plurality of rooms. The first mass member hopper 310 is opened/closed in response to a control signal from the control unit to feed the mass members to the counterweight 20. In addition, the mass member container 312 has a slant so that the mass members 1 contained therein can gather together in one portion. At one end of the slant, a mass member feeding hole 316 is formed to be opened/closed in response to an opening/closing signal from the control unit 40. A movable pipe 318 is arranged at one side of the mass member feeding hole 316. The movable pipe 318 is designed to be variable in length in response to a control signal from the control unit 40 to guide the mass members 1 discharged out of the mass member feeding hole 316 to the mass member inlet 212 of the counterweight 20. That is, when the elevator car 10 stays at a target floor after being elevated, the movable pipe 318 is controlled by the control signal of the control unit 40 to connect the first mass member hopper 310 with the counterweight 20, so that the mass members 1 can be stably fed.

Next, the second mass member hopper 320 is arranged in a lower part of the elevator shaft where the elevator system is installed. The second mass member hopper 320 has a mass member container 322 for collecting the mass members 1 discharged from the counterweight 20. Similarly, the second mass member hopper 320 also has a movable pipe 324 for guiding the mass members 1 discharged from the counterweight 20. The movable pipe 324 is also designed to be variable in length in response to a control signal from the control unit 40 in order to guide the mass members 1 discharged out of the mass member outlet 230 of the counterweight 20 to the feed screw unit 330 stably. Here, the mass member 1 automatically rolls or slides on a slant of the second mass member hopper 320 to feed into the feed screw unit 330, which will be described later.

Referring to FIG. 4, the feed screw unit 330 has an inlet 331 on one side, an outlet 332 on the other side, a casing 333 having an inner space, a feed screw 334 rotatably installed inside the inner space of the casing 333, and a drive motor 335. With rotating force from the drive motor 335, the mass members 1 introduced through the inlet 331 are transported from the bottom to the top through a transport pipe 336.

That is, the drive motor 335, when actuated, rotates the feed screw 334 connected to the output side of the drive motor 335. Here, when the feed screw 334 rotates counter-clockwise, the mass members 1 stored in the mass member container 322 are charged into the inlet 331 of the casing 333 and move upward along a groove of the feed screw 334. At the upper end, the mass members 1 are discharged through the outlet 332 of the casing 333 and are then transported upward in succession through the transport pipe 336.

The control unit 40 is installed in a control panel of the elevator system, and connected to a power cable 5 moving along with the elevator car 10 to control and manage the speed and operation of the elevator car 10. The control unit 40 also controls the feeding of the mass members 1 to the counterweight 20 from the mass member containers 310 and 320 in proportion to the weight of passengers or freight measured by the electronic scales 110 and 220 installed respectively in the elevator car 10 and the counterweight 20, or to be discharged from the counterweight 20 to the mass member containers 310 and 320.

That is, the control unit 40 controls the mass members 1 stored in the first mass member hopper 310 to feed into the counterweight 20 or the mass members 1 loaded in the counterweight 20 to be discharged to the second mass member hopper 320 in response to a weight measurement signal from the electronic scales of the elevator car 10 and the counterweight 20. In addition, the control unit 40 controls the opening/closing of the mass member outlet 214 of the counterweight 20, the opening/closing of the mass member feeding hole 316 of the first mass member hopper 310, the operation of the movable pipe 318 and the operation of the movable pipe 324 of the second mass member hopper 320, and cooperatively controls the operation of the feed screw unit 330.

Hereinafter, a more detailed description will be made of the elevating operation of the small power elevator system according to the preferred embodiment of the invention having the above-described structure.

FIG. 5 is a view illustrating the elevator system according to a preferred embodiment of the invention, in which the elevator car has arrived at the top floor and the counterweight has arrived at the bottom floor.

Referring to FIG. 5, the mass members 1 are stacked in the second mass member hopper 320. Thanks to the slanted bottom of the second mass member hopper 320, the mass members 1 move into the casing 333 of the feed screw unit 330 and into the feed screw 334. Then, as the feed screw 334 is rotated by the drive motor 335, the mass members 1 are vertically transported along the transport pipe 336 to the first mass member hopper 310 in succession, where the mass members 1 are stored.

In this position, when a passenger pushes an up bottom inside the elevator car, the electronic scale 110 installed in the bottom of the elevator car 10 measures the weight of the elevator car 10 and the total weight of the passengers, classifies the measured weight into heavy, medium and light weights, and sends a measurement signal to the control unit 40 electrically connected therewith before the departure of the elevator car 10.

The control unit 40 calculates the feeding amount of the mass members 1 so that the total weight of the counterweight and the mass members 1 loaded therein is greater than the total weight of the elevator car 10 (including the passengers), connects the movable pipe 318 of the first member hopper 310 to the mass member inlet 212 of the counterweight 20, and opens and closes the doors 314 and mass member feeding holes 316 of the mass member container 312. Here, the number of doors 314 to open is classified into many, medium, and few. In the case where a small number of passengers is in the elevator car, one of the doors 314 is moved to open in response to a signal from the control unit. In the case where a large number of passengers is present in the elevator car, all of the doors 314 are opened. In either case, the mass members 1 in the mass member container 312 enter the counterweight through the mass member feeding hole 316 and the movable pipe 318. The drawing illustrates all of the doors 314 opened in the case where a large number of passengers is in the elevator car. Once all of the mass members 1 are loaded into the box 210 of the counterweight 30, the mass member feeding hole 316 is closed and the movable pipe 318 returns to the original position. Then, a cable gripper or an electronic brake (not shown) gradually decreases pressure so that the counterweight 20 moves downward under self-weight but the elevator car 10 rises in the opposite direction. If the total weight of the mass members 1 fed and the counterweight 20 is set to be about 1.5 to 2 times the total weight of the elevator car 10 and the passengers, the elevator car 10 is driven upward and the counterweight 20 moves down, so that the elevator car 10 can arrive to a target floor desired by a passenger.

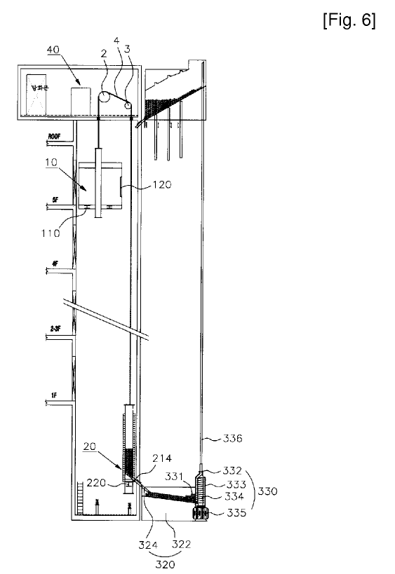

FIG. 6 is a view illustrating the elevator system according to another preferred embodiment of the invention, in which the elevator car has arrived at the top floor and the counterweight has arrived at the bottom floor.

Referring to FIG. 6, in this embodiment, the elevator car 10 stands by at the top floor (5th floor) and the counterweight 20 is moved down to the bottom floor (1st floor) so that the mass members 1 in use for weight enhancement/reduction are discharged to the second mass member hopper 320 installed in the bottom floor.

In this position, when a passenger pushes a down button inside the elevator car, the electronic scale 110 installed under the bottom of the elevator car 10 measures the weight of the elevator car 10 and the total weight and sends a measurement signal to the control unit 40, electrically connected thereto, indicating the departure of the elevator car 10.

The control unit 40 calculates the discharging amount of the mass members 1 so that the counterweight and the mass members loaded therein weigh less than the total weight of the elevator car 10, connects the movable pipe 324 of the second mass member hopper 320 to the mass member outlet 214 of the counterweight 20, and opens the mass member outlet 214 of the counterweight 20, so that the mass members 1 are discharged to the second mass member hopper 320.

In this case, the electronic scale 220 detects the weight of the mass members 1 discharged from the counterweight 20, and when the weight of the discharged mass members reaches a calculated value, sends a signal again to the control unit 40 to close the mass member outlet 214. As the movable pipe 324 returns to the original position, the cable gripper or electronic brake (not shown) gradually decreases pressure so that the elevator car 10 is moved downward by its own weight, but the counterweight 20 is driven upward.

If a building is a very large structure, such as an intelligent building, upper first mass member hoppers 310 and lower second mass member hoppers 320 may be installed at several points between the top and bottom floors. That is, in the case where the elevator car, having been driven upward to a specific floor, is to be moved down without reaching the top floor, the elevator car 10 can be moved downward when the mass members 1 are discharged from the counterweight 20 to the second mass member hopper 320. Likewise, the elevator car can be also driven in the opposite situation. However, the mass member hoppers 310 and 320 may be installed on every third or fifth floor to suitably satisfy demands when it is inefficient to install the hoppers 310 and 320 on every floor. In this case, if the mass members 1 contained in a mass member hopper 310 or 320 on a specific floor exceed or are short of a predetermined amount, based on a detection signal from an electronic scale (not shown) installed in the mass member hopper 310 or 320, the mass members 1 are discharged or fed through the transport pipe 333 of the feed screw unit 330.

In the meantime, in the case where the building is a five floor building, even if all passengers get off the elevator car at the third floor, the elevator car 10 is driven to the fifth floor and the counterweight 20 arrives at the reference or bottom floor. Then, when all of the mass members 1 are discharged to the second mass member hopper 320, the elevator car 10 moves downward in response to a signal from the control unit 40.

When the small power elevator system is driven up or down, two of three stages of the drive motor which are not electrically connected can be changed in position in response to a signal from the control unit 40, so that the drive motor can act as a power generator as well as a brake. That is, dynamic braking is used in winter, so that electric power generated from the drive motor may be discharged in the form of heat energy by means of a resistor. In other seasons, regenerative braking is used, so that electric power generated may be sent to an aeration tank of a sewage disposal tank. With such dynamic or regenerative braking, it is possible to make the elevator car move at a constant speed. The capacity of the drive motor is determined according to the speed of the elevator car.

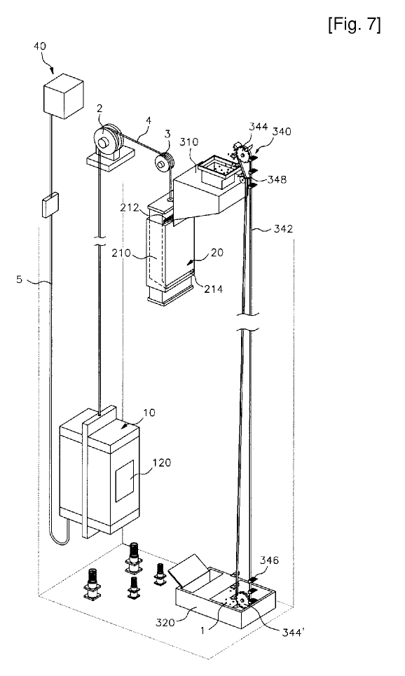

FIG. 7 is a perspective view illustrating a small power elevator system according to a further preferred embodiment of the invention, in which a bucket conveyor unit 340 is provided as the mass member feeder 30.

Describing the bucket conveyor unit 340 in more detail with reference to FIG. 7, the bucket conveyor unit 340 includes a conveyor 342 vertically arranged adjacent to the first and second mass member hoppers 310 and 320, a ratchet gear 344 arranged in an upper portion of the vertical conveyor 342 to be adjacent to the first mass member hopper 310, a ratchet gear 344′ arranged in a lower portion of the vertical conveyor 342 to be adjacent to the second mass member hopper 320, and a plurality of buckets 346 mounted on the vertical conveyor 342, in which each of the buckets 346 can contain at least two mass members 1. The bucket conveyor unit 340 also includes a tension gear 348, arranged at one side of the vertical conveyor 342 to apply tension thereto, and a drive motor (not shown) for driving the vertical conveyor 342, arranged rearward of a central portion of the lower ratchet gear 344′. The buckets 346 mounted on the vertical conveyor 342 enter the second mass member hopper 320 filled with a number of mass members 1 while moving up and down. Accordingly, some of the mass members 1 are carried by the bucket 346 and transported upward in succession. When the buckets 346 turn over at the end of the vertical transport, the mass members 1 drop from the buckets 346 into the first mass member hopper 310.

The following description will be given of the small power elevator system of the invention installed in a 20-story building having a height of 60 m.

In this embodiment, it will be assumed that the passenger elevator system is for 11 persons and that the drive motor for driving the elevator system has a power capacity of 11 kW.

First, it will be assumed that the mass members 1 of the invention are steel balls. In the case of using 5.5 kW as the capacity of the conveyor for raising the steel balls 60 m to the top floor of the building, 7 minutes will be spent to raise the steel balls when the steel balls are fed at a rate of 0.28 tons per minute and the weight of the steel balls necessary for driving the small power elevator system is at least 1.96 tons. Here, 65 kg (average passenger weight)×11 (passengers)=715 kg (capacity of the elevator car); the elevator car weighs 1 ton; the counterweight 20 weights 0.6 tons; and 2.5 tons (1.71×1.5)−0.6 tons (counterweight 20)=1.96 tons. Since the elevator car is rarely full in a common apartment building, it is possible to properly satisfy demand by installing the first mass hopper 310 in the top floor of the apartment building to have a capacity of about 4 tons.

Such an elevator system is suitable not only for passenger elevators but also for observation elevators and elevators for the disabled. If the time required for feeding and discharging the steel balls causes inconvenience owing to frequent interruptions, the steel balls may be made of a material having a higher specific gravity.

A general elevator system uses a drive motor having a capacity of 11 kW, which requires a transformer capacity of 50 KVA. This increases basic rates. Wattage-dependent rates also increase with the elevator system suddenly stopping and departing. Accordingly, the pad transformer and the pole transformer must be increased in capacity. In the middle of the night, when the elevator system seldom operates, the dedicated transformer of the elevator system has increased no-load loss. Even with a shared transformer, transformer capacity also increases corresponding to 50 KVA, which also increases no-load loss accordingly.

However, in a case where the small power elevator system of the invention is provided with a 5.5 kW conveyor for upward hoisting, the magnitude of about 5.5 kW allows Y-Δ starting. This makes it possible to additionally use 5.5 kW of capacity from the existing transformer used for lighting and electric heating, without having to add a separate transformer. Accordingly, the small power elevator system of the invention can reduce electric charges such as basic rates corresponding to 50 KVA, usage rates and no-load power rates. Thus, it is possible to save a remarkable amount of energy while preventing conventional problems. Otherwise, harmonics caused by inverter's operation would have adverse effects on other devices and transformer capacity would have to be increased according to the capacity of the drive motor.

Hereinafter, electric charges of the small power elevator system of the invention will be compared in detail with those of conventional elevator systems.

In the calculation of savings in electric charges, costs associated with elevator interior lighting devices and door opening/closing will be excluded since they are substantially the same in both cases. Costs associated with the drive motor will be examined in detail as follows:

In case of general electricity (e.g., household electricity) with high voltage A (early 2006), basic rates are 5,480 won (per kW; cf. won is Korean monetary unit), wattage-dependent rates are 89.8 won (kW/mean) (e.g., mean maximum load, from which a light load is excluded, since it is used little), the building is 20 multi-floored and 60 m high, an elevator system is operated for an average of eight hours daily, and a drive motor of the elevator system has a capacity of 11 kW. Then, electric charges for a conventional elevator system will be as follows: Basic rates are 5,480 won×11 kW×1.1 (VAT)=66,308 won per month; wattage-dependent rates are 89.8 won×11 kW×8 (hours)×30 (days)×1.1 (VAT)=260,779 won per month; and thus total electric charges will be 327,087 won per month, or 3,925,044 won per year.

However, in the case where the small power elevator system of the invention is applied thereto, the drive motor 335 of the feed screw unit 330 has a capacity of 5.5 kW, and 0.5 kW is consumed to open/close the mass member outlet 214 of the counterweight 20 and the mass member feeding hole 316 of the first mass member hopper 310. Then, electric charges will be as follows: Basic rates are 5,480 won×6 kW (5.5 kW+0.5 kW)×1.1 (VAT)=36,168 won per month; wattage-dependent rates are 89.8 won×6 kW×8 (hours)×30 (days)×1.1 (VAT)=142,243 won per month; and thus total electric charges will be 178,411 won per month, or 2,140,932 won per year.

Accordingly, the difference of electric charges between the small power elevator system of the invention and the conventional elevator system is 1,784,112 won per year. It can be understood that electric charges of 1,784,112 won per year can be saved, but those costs associated with elevator interior lighting, ventilation and door opening/closing are excluded from the comparison, since they are substantially the same in both cases.

Furthermore, the difference will increase further with an increase in no-load loss due to the use of a separate transformer and longer operation time.

In addition, the operation mode of the invention can be compared with the conventional inverter type as follows: First, the inverter is expected to generate high frequency waves or harmonics. The small power elevator system of the invention can save more energy when the drive motor used in the feed screw or conveyor belt is used as an inverter. As a fundamental difference, the small power elevator system of the invention needs to supply electric power to the drive motor 335 of the feed screw unit 330 for hoisting the mass members 1 to an upper floor since the elevator car 10 is driven upward under the weight of the mass members 1, but the elevator car 10 is moved down by its own weight. Therefore, with the other conditions the same, energy consumption is advantageously halved.

As set forth above, the small power elevator system of the invention includes the upper first mass member hopper 310 and the lower second mass member hopper 320 inside upper and lower walls of the elevator shaft, and includes the feed screw unit 330 connecting the first and second mass member hoppers 310 and 320 so that the mass members 1 can be fed upward and downward efficiently. The electronic scale 110 installed in the bottom of the elevator car 10 sends a signal associated with the number of passengers and the weight of the elevator car, so that the control unit 40, electrically connected to the former, detects the signal. Then, the control unit 40 opens/closes the mass member feeding hole 314 of the first mass member hopper 310 to feed a specific amount of the mass members 1 to the counterweight 20 so that the counterweight 20 moves down under the weight thereof, but the elevator car 10 is driven under the weight of the counterweight 20. Once the elevator car 10 arrives at the top floor, the counterweight 20 at the bottom or reference floor discharges the mass member 1 to the second mass member hopper 320 in response to a signal from the control unit 40.

Then, the counterweight 20 becomes lighter than the elevator car 10 so that the elevator car 10 moves down but the counterweight 20 is driven upward. Here, the elevator 10 is moved down by its own weight without the drive motor being supplied with electric power, thereby saving a remarkable amount of energy.

While the present invention has been described with reference to the particular illustrative embodiments and the accompanying drawings, it is not to be limited thereto, but will be defined by the appended claims. It is to be appreciated that those skilled in the art can substitute, change or modify the embodiments into various forms without departing from the scope and spirit of the present invention.

### INDUSTRIAL APPLICABILITY

In the invention, an uninterruptable power supply can be provided at the bottom of the elevator shaft in preparation for an accident concerning elevator stability. This also can reduce the amount of power consumption and stably supply power so that the elevator system can be stably operated according to the capacity of the uninterruptable power supply in the event of a power failure.

Furthermore, the elevator system of the invention is suitable for elevator systems for emergencies and observation, and high speed elevators. When used for these applications, the elevator system of the invention can save more energy and enhance safety. The elevator system of the invention is also applicable to a large capacity freight lift.

1. A small power elevator system installed in an elevator shaft of a building, comprising:
a passenger or freight elevator car having an electronic scale installed in a bottom thereof to measure a weight of loaded passengers or freight;
a counterweight connected to the elevator car and adapted to be moved in a direction opposite that of the elevator car by addition or removal of mass members according to a weight of the elevator car;
a mass member feeder for feeding the mass members to the counterweight; and
a control unit for controlling the mass members to be fed from the mass member feeder to the counterweight or discharged from the counterweight to the mass member feeder according to the weight of the elevator car,
wherein, in a case of driving the elevator car upward, a total weight of the elevator car and the passengers or freight is measured, and the mass members are fed to the counterweight so that the counterweight has a total weight greater than that of the elevator car, to thus drive the elevator car upward, and in a case of driving the elevator car downward, the total weight of the elevator car and the passengers or freight is measured and the mass members are discharged from the counterweight so that the counterweight has a total weight less than that of the elevator car to let the elevator car be moved down by its own weight.

2. The small power elevator system according to claim 1, wherein the counterweight includes:
a box having a mass member inlet for receiving the mass members from the mass member feeder and a mass member outlet installed in a lower portion of the box to discharge a certain amount of the mass members to the mass member feeder in response to a control signal from the control unit; and
an electronic scale installed in a bottom of the box to measure a weight of the mass members inside the box and send a measurement value to the control unit.

3. The small power elevator system according to claim 1, wherein the mass member feeder includes:
a first mass member hopper arranged in an upper portion of the elevator shaft to feed a certain amount of the mass members to the counterweight in response to a control signal from the control unit;
a second mass member hopper arranged in a lower portion of the elevator shaft to collect the mass members discharged from the counterweight; and
a feed screw unit including a casing having an inlet formed at one portion thereof, an outlet formed at another portion thereof, an inner space, a feed screw arranged inside the inner space of the casing, and a transport pipe, wherein, when the mass members discharged from the second mass member hopper are received through the inlet of the casing, the feed screw transports the mass members upward through the outlet of the casing and the feeding pipe using a rotating force of the drive motor in order to feed the mass members to the first mass member hopper.

4. The small power elevator system according to claim 3, wherein the first mass member hopper includes:
a mass member container fixed to one portion of the elevator shaft to collect the mass members fed from a conveyor belt of the feed screw unit, the mass member container having a feeding hole in a lower portion thereof;
a plurality of openable doors arranged vertically to separate an inner space of the mass member container into a plurality of areas; and
a movable pipe for guiding the mass members exiting through the feeding holes of the mass member container into the counterweight,
wherein the openable doors are selectively opened/closed in response to the control signal from the control unit to feed the mass members to the counterweight.

5. The small power elevator system according to claim 3, wherein the second mass member hopper includes:
a mass member container fixed to one portion of the elevator shaft to collect the mass members discharged from the counterweight; and
a movable pipe arranged in an upper portion of the mass member container to guide the mass members discharged from the counterweight.

6. The small power elevator system according to claim 1, wherein the elevator car has a graphic monitor arranged in an inner wall surface to display the mass members being fed or discharged.
